(19) United States
(12) Patent Application Publication
(10) Pub. No.: US 2026/0320319 A1
(43) Pub. Date: Oct. 15, 2026

(54) System and Wireless Device for Facilitating Access to Device Information

(71) Applicant: Future Dial, Inc., Sunnyvale, CA (US)

(72) Inventors: Jisheng Li, Los Altos, CA (US); Chen Chen, San Ramon, CA (US); Yueting Zhang, San Jose, CA (US); Haofeng Song, Cupertino, CA (US); Jimish Dodia, San Jose, CA (US)

(21) Appl. No.: 19/176,078

(22) Filed: Apr. 10, 2025

(51) Int. Cl. G06K 7/016; G06K 7/08; G06K 19/07; G06K 19/077

(52) U.S. Cl. CPC G06K 7/016; G06K 7/082; G06K 19/0723; G06K 19/07707

(57) ABSTRACT

A system and wireless device for facilitating access to device information are provided. The system includes the wireless device, which communicatively links to a device when the device is positioned on a wireless reader of the wireless device. The wireless reader reads information associated with the device positioned on the wireless reader and provide the information to a computing device, such as in response to a command. The computing device determines a status of the device based on the information associated with the device, and determines whether an operation or action needs to be performed with respect to the device. The computing device generates a signal to cause display of the information and the status associated with the device on a region of a user interface.

### FIELD OF THE INVENTION

The present application relates to device access technologies, wireless technologies, communication technologies, device inspection technologies, user interface technologies, device analysis technologies, and, more particularly, to a system and wireless device for facilitating access to device information.

### BACKGROUND

In today's society, an increasing number of people utilize both e-commerce and retail locations to purchase and return various types of products. During traditional logistics processes, a manufacturer manufactures a product and provides the product to a distributor, which distributes the products to various retail locations. Once the products arrive at a retail location, they can be provided to customers that purchase the products. Sometimes the customers wish to return the products either because they are defective, because they are trading in the product for a new version of the product, or for other reasons. When returning the product, such as during a reverse logistics process, it is typically required to have the product evaluated and be in a certain condition before being transported back up the supply chain or before being sold to a new customer. Often times, when evaluating a product returned at a retail location, a customer representative of the retail location will manually inspect the product, test the product, and manually perform various activities with respect to the product. For example, for a smart watch that is being traded in, the customer representative may visually inspect the smart watch for any damage and then manually activate the smart watch. Once the smart watch is activated, the employee may perform a variety of tests, such as by utilizing a diagnostic tool, to ensure that the smart watch is operating as intended. In certain scenarios, the customer representative may also manually perform a hard reset, or perform a factory reset to erase all data, applications, and settings to get the smart watch back to its original state. Once the smart watch has been tested, the customer representative can manually enter in product details into a computer and then prepare the smart watch for shipment as part of the reverse logistics process. The foregoing process is time-intensive and tedious, and, when there are many devices to inspect and prepare, it can slow down operations at the retailer. Moreover, smart watches and other wearable devices tend to be more difficult to inspect because they have smaller user interfaces, often do not contain ports to connect to computers, and are small in size.

Based on at least the foregoing, there remains room for substantial enhancements to existing technologies and processes and for the development of new technologies and processes to facilitate inspections of devices and to optimize reverse logistics processes. For example, current technologies may be improved and enhanced to obtain device information more effectively at scale, determine the condition of devices, and display information in an easy-to-visualize format. Such improvements and enhancements to methodologies and technologies may provide for more effective reverse logistics operations, improved device inspection capabilities, reduced errors, improved customer service, among a variety of other benefits.

### SUMMARY

A system, wireless reader device, and methods for facilitating accessing of device information are disclosed. In particular, the system, wireless reader device, and methods can efficiently and effectively access and retrieve information from devices, such as devices being returned or traded-in by customers as part of a reverse logistics process. The system, wireless reader device and methods can be utilized to access and obtain information associated with devices including traditional ports, but also are capable of accessing and obtaining information from devices without traditional ports. In certain embodiments, the system and methods can incorporate the use of a unique wireless reader device, a wired reader device, a computing device (e.g., a mini-computer), a display device, and communication networks. A user, such as a customer representative can position a device on a wireless reader or connect the device to a wired reader. The wireless reader device and/or wired reader can instantly read device information from any device communicatively linked and/or connected to the wireless reader device and/or wired reader.

The information read from the device can be provided to a computing device either automatically or in response to a command from the computing device, which can determine a status of each device. For example, the status of the device can be that the device is ready for a next stage in the reverse logistics process or that an operation and/or activity needs to be performed with respect to a particular device before proceeding to the next stage of the reverse logistics process. The operation and/or activity can be performed by a user, such as the customer service representative or by the components of the system itself. The information associated with the device and/or the status of the device can be provided in a signal by the computing device to a display device to cause the display device to display the information and/or status of the device in a specific region of a user interface of the display device. Each device being read by the system can have a specific region on the user interface of the display device dedicated to displaying information and/or the status of the particular device. If a particular device needed an operation and/or activity performed with respect to the device, the displayed status and information can be updated in real time once the operation and/or activity to indicate that the operation and/or activity was performed and/or that the device is ready for a next stage of the reverse logistics process. Any number of devices can be read by the wireless and/or wired reader devices, thereby enabling rapid access to device information, visualization of device information, and readying of devices for stages of logistics processes at scale.

A system and wireless reader device for facilitating access to device information is provided. In certain embodiments, the system can include wireless reader device configured to wirelessly read information associated with a first device when the first device is positioned on the wireless reader device. The system can also include a computing device communicatively linked to the wireless reader device. The computing device can be configured to transmit a command to the wireless reader device to provide the information associated with the first device positioned on the wireless reader device. Additionally, the computing device can be configured to receive, in response to the command and from the wireless reader device, the information associated with the first device wirelessly read from the first device. Furthermore, the computing device can be configured to generate a first signal comprising the information associated with the first device to cause display of the information associated with the first device on a first region of a user interface.

A device, such as a wireless reader device for facilitating access to device information is provide. The device can include a housing and one or more wireless readers incorporated into the housing. A first wireless reader of the one or more wireless readers can be configured to communicatively link to a first device when the first device is positioned on the one or more wireless readers. In certain embodiments, the first device magnetically connects to the one or more wireless readers. In certain embodiments, the first wireless reader can be configured to wirelessly read information associated with the first device when the first device is positioned on the one or more wireless readers and communicatively linked to the first device. In certain embodiments, the first wireless reader can be configured to provide, such as in response to a command from a computing device, the information associated with the first device to the computing device to generate a signal to cause a display to output the information associated with the first device on a first region of a user interface.

A method for facilitating access to device information, such as by utilizing a wireless reader device, is provided. The method can include positioning a first device on a wireless reader of a wireless reader device. In certain embodiments, the method can include communicatively linking the first device to the wireless reader device based on the positioning of the first device on the wireless reader. In certain embodiments, the method can include reading, by utilizing the wireless reader, information associated with the first device. In certain embodiments, the method can include providing the information associated with the first device to a computing device. In certain embodiments, the method can include determining, by utilizing the computing device, a status of the first device based on the information associated with the first device. In certain embodiments, the method can include generating, by utilizing the computing device, a signal to cause display of the information and the status associated with the first device on a first region of a user interface.

These and other features of the systems, devices, and methods for facilitating access to device information are described in the following detailed description, drawings, and appended claims.

### BRIEF DESCRIPTION OF THE DRAWINGS

FIG. 1 is a schematic diagram of a system for facilitating access to device information according to embodiments of the present disclosure.

FIG. 2 illustrates various components of a system for facilitating access to device information including a wireless reader, a wired reader, a computing device, and a display device according to embodiments of the present disclosure.

FIG. 3 illustrates exemplary devices that can be read by a system for facilitating access to device information according to embodiments of the present disclosure.

FIG. 4 illustrates exemplary device information and status information for a plurality of devices being read by a system for facilitating access to device information according to embodiments of the present disclosure.

FIG. 5 is a flow diagram illustrating a sample method for facilitating access to device information according to embodiments of the present disclosure.

FIG. 6 is a schematic diagram of a machine in the form of a computer system within which a set of instructions, when executed, may cause the machine to facilitate access to device information of devices according to embodiments of the present disclosure.

### DETAILED DESCRIPTION OF THE DRAWINGS

A system 100, wireless reader device (e.g., wireless reader device 125, 210), and methods for facilitating accessing of device information are disclosed. In particular, the system 100, wireless reader device, and methods can efficiently and effectively access and retrieve information from devices, such as devices being returned or traded-in by customers, such as at a retail location of a business. The returned or traded-in devices can be analyzed for preparation for reverse logistics processed to ensure that the devices are in a ready condition for potential resale, refurbishment, or other desired process. The system 100, wireless reader device and methods can be utilized to access and obtain information associated with devices including traditional ports (e.g., diagnostic or other ports), but also are capable of accessing and obtaining information from devices without traditional ports, such as wireless devices (e.g., smart watches) containing wireless communication modules and/or systems. In certain embodiments, the system 100 and methods can incorporate the use of a unique wireless reader device, a wired reader device, a computing device (e.g., a mini-computer), a display device, other devices, and/or communication networks. A user, such as a customer representative, can position a device on a wireless reader or connect the device to a wired reader. The wireless reader device and/or wired reader can instantly read device information from any device communicatively linked and/or connected to the wireless reader device and/or wired reader.

In certain embodiments, the information read from the device can be provided to a computing device either automatically or in response to a command from the computing device, which can determine a status of each device. For example, the status of the device can be that the device is ready for a next stage in the reverse logistics process or that an operation and/or activity needs to be performed with respect to a particular device before proceeding to the next stage of the reverse logistics process. The operation and/or activity can be performed by a user, such as the customer service representative, and/or by the devices of the system itself. The information associated with the device and/or the status of the device can be provided in a signal by the computing device to a display device to cause the display device to display the information and/or status of the device in a specific region of a user interface of the display device. For example, the information and status for one device can be displayed on a top left region of the user interface and the information and status for another device can simultaneously be displayed in a top right region of the user interface. In certain embodiments, each device being read by the system 100 can have a specific region (e.g., a rendered tile) on the user interface of the display device dedicated to displaying information and/or the status of the particular device. If a particular device needed an operation and/or activity performed with respect to the device, the displayed status and information can be updated in real time once the operation and/or activity to indicate that the operation and/or activity was performed and/or that the device is ready for a next stage of the reverse logistics process. Notably, any number of devices can be read by the wireless and/or wired reader devices of the system 100, thereby enabling rapid access to device information, visualization of device information, and readying of devices for stages of logistics processes at scale, while also minimizing errors and increasing accuracy of the determined information and/or status of each device.

A system and wireless reader device (or wireless device) for facilitating access to device information is provided. In certain embodiments, the system can include wireless reader device configured to wirelessly read information associated with a first device when the first device is positioned on the wireless reader device. The system can also include a computing device communicatively linked to the wireless reader device. The computing device can be configured to transmit a command to the wireless reader device to provide the information associated with the first device positioned on the wireless reader device. Additionally, the computing device can be configured to receive, in response to the command and from the wireless reader device, the information associated with the first device wirelessly read from the first device. Furthermore, the computing device can be configured to generate a first signal comprising the information associated with the first device to cause display of the information associated with the first device on a first region of a user interface.

In certain embodiments, the wireless reader device can include a plurality of wireless readers positioned on the wireless reader device. In certain embodiments, the first device can be configured to be positioned onto a first wireless reader of the plurality of wireless readers such that the first device magnetically connects to the first wireless reader. In certain embodiments, the first wireless reader can be configured to charge a power source of the first device when the first device is magnetically connected to the first wireless reader by inducing a current in a charging coil of the first device. In certain embodiments, the computing device can further configured to determine a status of the first device based on the information associated with the first device wirelessly read from the first device. In certain embodiments, the computing device can be further configured to include the status in the first signal causing display of the information associated with the first device on the first region of the user interface. In certain embodiments, the computing device can be further configured to provide an indication of an operation to perform with respect to the first device based on the status of the first device. In certain embodiments, the operation can include performance of a reset of the device, performance of a reformat of the device, any other operation, or a combination thereof.

In certain embodiments, the wireless reader device can be further configured to wirelessly read additional information associated with the first device after the operation has been performed, and provide the additional information associated with the first device to the computing device. In certain embodiments, the computing device can be further configured to determine, based on the additional information, that the operation has been performed. In certain embodiments, the computing device can be further configured to generate, based on the additional information, a second signal to cause display of an indication that the operation has been performed at the first region of the user interface.

In certain embodiments, the system can further include a wired reader. In certain embodiments, the wired reader can be configured to read information associated with a second device when the second device is connected to a first connector of a plurality of connectors the wired reader. In certain embodiments, the wired reader can be further configured to provide the information associated with the second device to the computing device. In certain embodiments, the computing device can be further configured to generate a second signal comprising the information associated with the second device to cause display of the information associated with the second device on a second region of the user interface. In certain embodiments, the system can further include a display device including the user interface and configured to display the information associated with the first device on the first region of the user interface, and/or the information associated with the second device on the second region of the user interface. In certain embodiments, the wireless reader device can be configured to perform a reset, a reformat, or a combination thereof, for the first device when the first device is positioned on the wireless reader device.

A device, such as a wireless reader device for facilitating access to device information is provided. The device can include a housing and one or more wireless readers incorporated into the housing. A first wireless reader of the one or more wireless readers can be configured to communicatively link to a first device when the first device is positioned on the one or more wireless readers. In certain embodiments, the first device magnetically connects to the one or more wireless readers. In certain embodiments, the first wireless reader can be configured to wirelessly read information associated with the first device when the first device is positioned on the one or more wireless readers and communicatively linked to the first device. In certain embodiments, the first wireless reader can be configured to provide, such as in response to a command from a computing device, the information associated with the first device to the computing device to generate a signal to cause a display to output the information associated with the first device on a first region of a user interface.

In certain embodiments, the one or more wireless readers can communicatively link with the first device when the first device is positioned on the one or more wireless readers by activating a wireless module of the first device via an activation signal. In certain embodiments, the one or more wireless readers can include a flashing tool that can be configured to reset the first device, reformat the first device, update software on the first device, or a combination thereof, such as when the first device is communicatively linked to the one or more wireless readers.

A method for facilitating access to device information, such as by utilizing a wireless reader device, is provided. The method can include positioning a first device on a wireless reader of a wireless reader device. In certain embodiments, the method can include communicatively linking the first device to the wireless reader device based on the positioning of the first device on the wireless reader. In certain embodiments, the method can include reading, by utilizing the wireless reader, information associated with the first device. In certain embodiments, the method can include providing the information associated with the first device to a computing device. In certain embodiments, the method can include determining, by utilizing the computing device, a status of the first device based on the information associated with the first device. In certain embodiments, the method can include generating, by utilizing the computing device, a signal to cause display of the information and the status associated with the first device on a first region of a user interface.

In certain embodiments, the method can further include determining if an operation needs to be performed on the first device based on the information associated with the first device. In certain embodiments, the method can include causing an alert to be displayed on the first device that indicates that the operation needs to be performed on the first device.

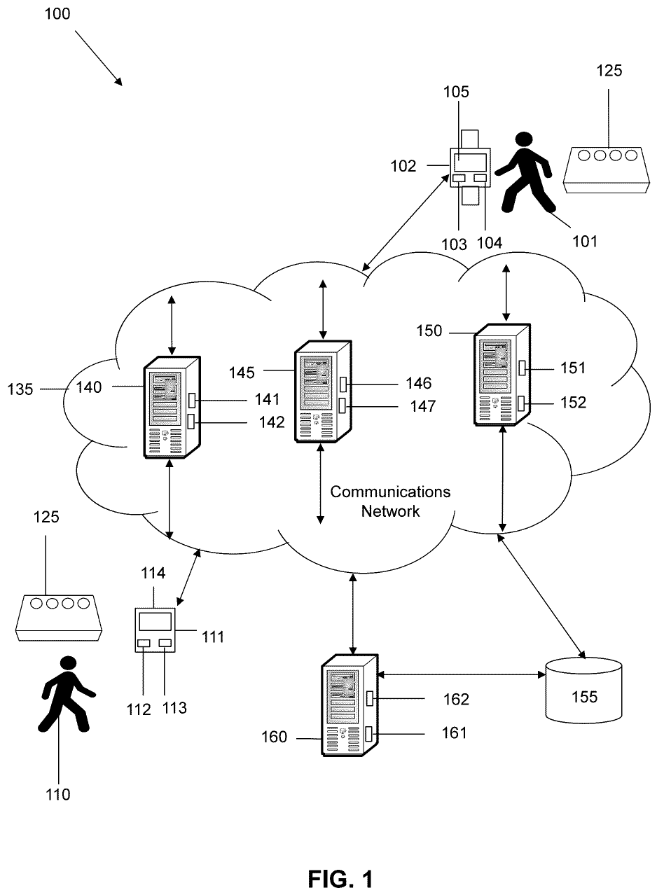

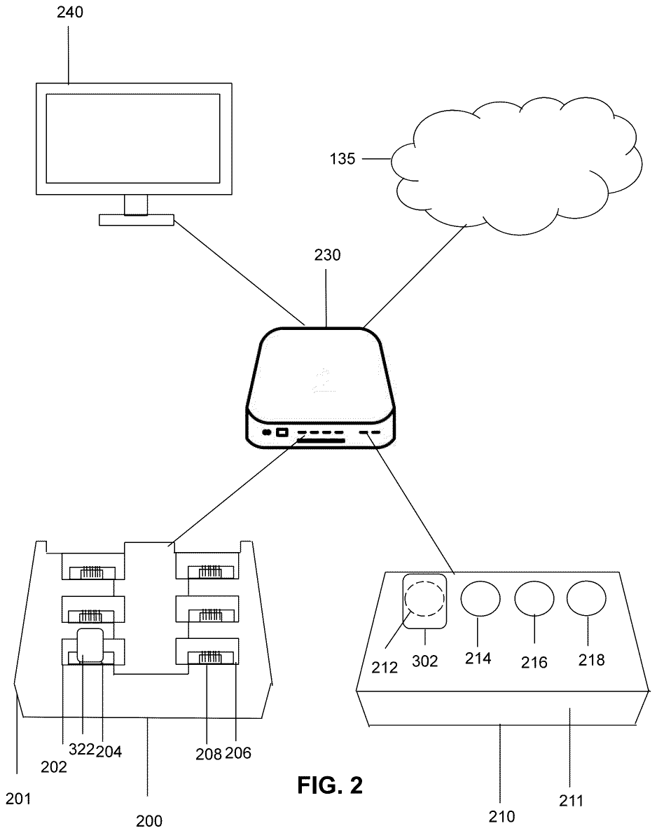

As shown in FIG. 1, a system for facilitating access to device information according to embodiments of the present disclosure is disclosed. Notably, the system 100 can operate using just a subset of the components as illustrated in FIGS. 2 and/or 3 (e.g., a wireless reader, the computing device, the display device, devices 302, 322, etc.) and does not require the use of all components of FIG. 1 to provide the operative functionality of the present disclosure. In certain embodiments, however, functionality described in the present disclosure can utilize one or more of the components illustrated in FIG. 1 to further enhance and/or support the functionality described in the present disclosure. Notably, the system 100 may be configured to support, but is not limited to supporting, device access technologies and services, device inspection technologies and services, wireless technologies and services, user interface technologies and services, device analysis technologies and services, artificial intelligence services and systems, machine learning services and systems, content delivery services, cloud computing services, satellite services, telephone services, voice-over-internet protocol services (VoIP), software as a service (SaaS) applications, platform as a service (PaaS) applications, mobile applications and services, and/or any other computing applications and services. Notably, the system 100 may include a first user 101, who, for example, can utilize a first user device 102 to access data, content, and services, or to perform a variety of other tasks and functions. As an example, the first user 101 may utilize first user device 102 to transmit signals to access various online services and content, such as those available on an internet, on other devices, and/or on various computing systems. As another example, the first user device 102 may be utilized by the first user 101 to access an application, devices, and/or components of the system 100 that provide any or all of the operative functions of the system 100. For example, the first user 101 may utilize the first user device 102 to access an application having a user interface that enables the first user 101 to interact with the first user device 102, perform a reset of the first user device 102, perform a reformat of the first user device 102 (e.g., of an operating system of the first user device 102), communicate with devices, programs, and/or components of the system 100, perform any other operative functionality, or a combination thereof.

In certain embodiments, the first user 101 may be a customer representative at a retailer that can receive products from users for trade in and/or return. The customer representative can be tasked with ensuring that the product (e.g., first user device 102) operates as intended and/or does not have an unacceptable amount of damage, such as before approving the product for a next stage of a reverse logistics process. The reverse logistics process can involve having the product being reviewed being shipped from the retailer to a distributor and/or to a manufacturer for ultimate resale, refurbishment, or for other purposes. In certain embodiments, the first user 101 can be any type of person, a robot, a humanoid, a program, a computer, any type of user, or a combination thereof.

In certain embodiments, in addition to being a potential device for trade in or return, the first user device 102 can also be utilized by the first user to interact with the system 100, other users of the system 100, or a combination thereof. In certain embodiments, the first user device 102 may include a memory 103 that includes instructions, and a processor 104 that executes the instructions from the memory 103 to perform the various operations that are performed by the first user device 102. In certain embodiments, the processor 104 may be hardware, software, or a combination thereof. The first user device 102 may also include an interface 105 (e.g. screen, monitor, graphical user interface, etc.) that may enable the first user 101 to interact with various applications executing on the first user device 102 and to interact with the system 100. In certain embodiments, the first user device 102 may be and/or may include a computer, any type of sensor, a laptop, a set-top-box, a tablet device, a phablet, a server, a mobile device, a smartphone, a smart watch, and/or any other type of computing device. Illustratively, the first user device 102 is shown as a smart watch device in FIG. 1. In certain embodiments, the first user device 102 may be utilized by the first user 101 to control and/or provide some or all of the operative functionality of the system 100. However, in certain embodiments, the first user device 102 can merely be the device from which information is to be accessed, formatted and/or reset.

In addition to using first user device 102, the first user 101 may also utilize and/or have access to additional user devices. As with first user device 102, the first user 101 may utilize the additional user devices to transmit signals to access various services and content and/or to perform the operative functionality of the system 100. The additional user devices may include memories that include instructions, and processors that executes the instructions from the memories to perform the various operations that are performed by the additional user devices. In certain embodiments, the processors of the additional user devices may be hardware, software, or a combination thereof. The additional user devices may also include interfaces that may enable the first user 101 to interact with various applications executing on the additional user devices and to interact with the system 100. In certain embodiments, the first user device 102 and/or the additional user devices may be and/or may include a computer, any type of sensor, a laptop, a set-top-box, a tablet device, a phablet, a server, a mobile device, a smartphone, a smart watch, a camera, and/or any other type of computing device, and/or any combination thereof. Sensors may include, but are not limited to, cameras, motion sensors, acoustic/audio sensors, pressure sensors, temperature sensors, light sensors, heart-rate sensors, blood pressure sensors, sweat detection sensors, eye-tracking sensors, breath-detection sensors, stress-detection sensors, any type of health sensor, humidity sensors, any type of sensors, or a combination thereof.

The first user device 102 and/or additional user devices may belong to and/or form a communications network. In certain embodiments, the communications network may be a local, mesh, or other network that enables and/or facilitates various aspects of the functionality of the system 100. In certain embodiments, the communications network may be formed between the first user device 102 and additional user devices through the use of any type of wireless or other protocol and/or technology. For example, user devices may communicate with one another in the communications network by utilizing any protocol and/or wireless technology, satellite, fiber, or any combination thereof. Notably, the communications network may be configured to communicatively link with and/or communicate with any other network of the system 100 and/or outside the system 100.

In certain embodiments, the first user device 102 and additional user devices belonging to the communications network may share and exchange data with each other via the communications network. For example, the user devices may share information associated with the users of the user devices, information identifying specifications of the user devices, information identifying user profiles for users of the user devices, information identifying device profiles for the user devices, information identifying the number of devices in the communications network, information identifying devices being added to or removed from the communications network, any other information, or any combination thereof.

The first user 101 can also utilize a wireless reader device 125 and/or wired reader device 200 to facilitate the reading and/or accessing of information associated with the first user device 102. In certain embodiments, the wireless reader device 125 can include any of the components and/or functionality as described for wireless reader device 210 and/or as otherwise described herein. In certain embodiments, the wireless reader device 125 can include, but is not limited to including, a flashing tool for resetting, erasing, and/or reformatting the first user device 102, a wireless charger(s), a universal serial bus (USB) male to mini component (e.g., USB 2.0 Male to Mini-B 1.5 FT), a USB type C to type A cable (e.g., USB Type C to Type A cable 1 ft), a multi-port USB hub (e.g., 7 port USB hub with 12V 3A PS), a USB dual type-C panel mount (e.g., a USB 3.1 Dual Type-C panel mount), a power jack socket (e.g., 5.5×2.1 mm DC power jack socket), a USB back panel mount (e.g., a USB 3.0 back panel mount 0.5 m), a splitter (e.g., a USB splitter 1 in 4 out 1 ft), a DC to USB power adapter, a voltage converter (e.g., voltage converter 12v to 5v 3A), a housing, slots of receiving the one or more wireless chargers, any other components, a processor, a memory, a communication module, or a combination thereof. In certain embodiments, the wireless reader device 125 can include GPS, cellular antennas, communication modules ((e.g., Z-wave, Bluetooth, Zigby, etc.), WiFi modules, any other communication components, or a combination thereof), any types of sensors, an input device (e.g., a button to activate or deactivate the wireless reader device 125, establish settings for the wireless reader device 125, activate modes of the wireless reader device 125, pair the wireless reader device 125 with other devices (e.g., via Bluetooth, WiFi, Z-wave, etc.), communicate with other devices of the system 100, perform other operations, or a combination thereof), an interface, a software application, a speaker, a microphone, any other components, or a combination thereof. In certain embodiments, the first user 101 can utilize the wireless reader device 125 to read information and data from devices (e.g., first user device 102 and/or second user device 110) and/or to exchange data with other devices of the system 100 and vice versa.

In addition to the first user 101, the system 100 may also include a second user 110. In certain embodiments, the second user 110 can also be a customer representative at a retail location or can be the user trading in or returning the first user device 102. In certain embodiments, the second user device 111 may be utilized by the second user 110 to transmit signals to request various types of content, services, and data provided by and/or accessible by communications network 135 or any other network in the system 100. In certain embodiments, the second user 110 may utilize the second user device 111 to access an application having a user interface that enables the first user 101 to communicate with the devices and/or components of the system 100, perform any other operative functionality, or a combination thereof. In certain embodiments, the second user 110 may be a robot, a computer, a vehicle (e.g. semi or fully-automated vehicle), a humanoid, an animal, any type of user, or any combination thereof.

The second user device 111 may include a memory 112 that includes instructions, and a processor 113 that executes the instructions from the memory 112 to perform the various operations that are performed by the second user device 111. In certain embodiments, the processor 113 may be hardware, software, or a combination thereof. The second user device 111 may also include an interface 114 (e.g. screen, monitor, graphical user interface, etc.) that may enable the first user 101 to interact with various applications executing on the second user device 111 and, in certain embodiments, to interact with the system 100. In certain embodiments, the second user device 111 may be a computer, a laptop, a set-top-box, a tablet device, a phablet, a server, a mobile device, a smartphone, a smart watch, and/or any other type of computing device. Illustratively, the second user device 111 is shown as a mobile device in FIG. 1. In certain embodiments, the second user device 111 may also include sensors, such as, but are not limited to, cameras, audio sensors, motion sensors, pressure sensors, temperature sensors, light sensors, heart-rate sensors, blood pressure sensors, sweat detection sensors, breath-detection sensors, eye-tracking sensors, stress-detection sensors, any type of health sensor, humidity sensors, any type of sensors, or a combination thereof. The second user 110 can also utilize a wireless reader device 125 (and/or wired reader device 200) to facilitate the reading and/or accessing of information associated with the second user device 111. In certain embodiments, the first user 101 can utilize the wireless reader device 125 (and/or wired reader device 200) to read information and data from devices (e.g., first user device 102 and/or second user device 110) and/or to exchange data with other devices of the system 100 and vice versa.

In certain embodiments, the first user device 102, the wireless reader devices 125, 210, wired reader device 200, the additional user devices, and/or the second user device 111 may have any number of software applications and/or application services stored and/or accessible thereon. For example, the first user device 102, the wireless reader devices 125, 210, wired reader device 200, the computing device 230, the additional user devices (e.g., devices 304, 324), and/or the second user device 111 may include applications for controlling and/or accessing the operative features and functionality of the system 100, applications for controlling the wireless reader devices 125, 210, the wired reader device 200, the computing device 230, cloud-based applications, VoIP applications, other types of phone-based applications, product-ordering applications, business applications, e-commerce applications, media streaming applications, content-based applications, media-editing applications, database applications, gaming applications, internet-based applications, browser applications, mobile applications, service-based applications, productivity applications, video applications, music applications, social media applications, any other type of applications, any types of application services, or a combination thereof. In certain embodiments, the software applications may support the functionality provided by the system 100 and methods described in the present disclosure. In certain embodiments, the software applications and services may include one or more graphical user interfaces so as to enable the first and/or potentially second users 101, 110 to readily interact with the software applications. The software applications and services may also be utilized by the first and/or potentially second users 101, 110 to interact with any device in the system 100, any network in the system 100, or any combination thereof. In certain embodiments, the first user device 102, the wireless reader devices 125, 210, wired reader device 200, the additional user devices, and/or potentially the second user device 111 may include associated telephone numbers, device identities, or any other identifiers to uniquely identify the first user device 102, wireless reader devices 125, 210, wired reader device 200, the additional user devices, and/or the second user device 111.

The system 100 may also include a communications network 135. The communications network 135 may be under the control of a service provider, any designated user, a computer, another network, or a combination thereof. The communications network 135 of the system 100 may be configured to link each of the devices in the system 100 to one another. For example, the communications network 135 may be utilized by the first user device 102 to connect with other devices within or outside communications network 135. Additionally, the communications network 135 may be configured to transmit, generate, and receive any information and data traversing the system 100. In certain embodiments, the communications network 135 may include any number of servers, databases, or other componentry. The communications network 135 may also include and be connected to a mesh network, a local network, a cloud-computing network, an IMS network, a VoIP network, a security network, a VoLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 140, 145, and 150 are shown as being included within communications network 135. In certain embodiments, the communications network 135 may be part of a single autonomous system that is located in a particular geographic region or be part of multiple autonomous systems that span several geographic regions.

Notably, the functionality of the system 100 may be supported and executed by using any combination of the servers 140, 145, 150, and 160. The servers 140, 145, and 150 may reside in communications network 135, however, in certain embodiments, the servers 140, 145, 150 may reside outside communications network 135. The servers 140, 145, and 150 may provide and serve as a server service that performs the various operations and functions provided by the system 100. In certain embodiments, the server 140 may include a memory 141 that includes instructions, and a processor 142 that executes the instructions from the memory 141 to perform various operations that are performed by the server 140. The processor 142 may be hardware, software, or a combination thereof. Similarly, the server 145 may include a memory 146 that includes instructions, and a processor 147 that executes the instructions from the memory 146 to perform the various operations that are performed by the server 145. Furthermore, the server 150 may include a memory 151 that includes instructions, and a processor 152 that executes the instructions from the memory 151 to perform the various operations that are performed by the server 150. In certain embodiments, the servers 140, 145, 150, and 160 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 140, 145, 150 may be communicatively linked to the communications network 135, any network, any device in the system 100, or any combination thereof.

The database 155 of the system 100 may be utilized to store and relay information that traverses the system 100, cache content that traverses the system 100, store data about each of the devices in the system 100 and perform any other typical functions of a database. In certain embodiments, the database 155 may be connected to or reside within the communications network 135, any other network, or a combination thereof. In certain embodiments, the database 155 may serve as a central repository for any information associated with any of the devices and information associated with the system 100. Furthermore, the database 155 may include a processor and memory or may be connected to a processor and memory to perform the various operation associated with the database 155. In certain embodiments, the database 155 may be connected to the servers 140, 145, 150, 160, the first user device 102, the second user device 111, wireless reader devices 125, 210, wired reader device 200, the computing device 230, the display device 240, the additional user devices, any devices in the system 100, any process of the system 100, any program of the system 100, any other device, any network, or any combination thereof.

The database 155 may also store information and metadata obtained from the system 100, store metadata and other information associated with the first and second users 101, 110, store device information obtained from devices (e.g., first user device 102, second user device 111, devices 304, 324, etc.), store status information for the devices, store user profiles associated with the first and second users 101, 110, store location data obtained from the devices, store signals indicating actions and/or operations to be performed with respect to devices being analyzed by the system 100, store device profiles associated with any device in the system 100, store signals generated by any of the components of the system 100, store communications traversing the system 100, stored information displayed on a display device 240, store user preferences, store information associated with any device or signal in the system 100, store information relating to patterns of usage relating to the user devices 102, 111, store any information obtained from any of the networks in the system 100, store historical data associated with the first and second users 101, 110, store device characteristics, store information relating to any devices associated with the first and second users 101, 110, store information associated with the communications network 135, store any information associated with stages in a reverse logistics process for a device, store any information generated and/or processed by the system 100, store any of the information disclosed for any of the operations and functions disclosed for the system 100 herewith, store any information traversing the system 100, or any combination thereof. In certain embodiments, the database 155 can store any number and/or type of machine learning algorithms. Furthermore, the database 155 may be configured to process queries sent to it by any device in the system 100.

Referring now also to FIGS. 2, 3, and 4 various components for facilitating access to device information of devices are provided. In certain embodiments, the components of FIGS. 2, 3, and 4 can be incorporated and/or integrated with the system 100 or can operate as a separate system. In certain embodiments, a wired reader 200, a wireless reader device 210, a computing device 230, a display device 240, and a communication network 135 can be provided. In certain embodiments, the wired reader 200 can be a device that can read device information from a device connected to the wired reader 200. In certain embodiments, the wired reader 200 can include a housing 201, a plurality of bays or slots 202, 206, connectors 204, 208 including pins for connecting to a port of a device (e.g., devices 102, 111, 302, 322), any number of ports (e.g., for connecting the wired reader 200 to the computing device 230, wireless reader 210, and/or display device 240), any other components, or a combination thereof. In certain embodiments, any number of bays or slots 202, 206, and connectors 204, 208 can be incorporated into the wired reader 200. In certain embodiments, a device port (e.g., a diagnostic port) of a device 322 can be connected to the pins of a connector 204 in bay 202. Once connected, the wired reader 200 can read information associated with the device and provide the information to the computing device 230 automatically or in response to a command issued from the computing device 230. The information that can be read from the device can include, but is not limited to, a size of a storage of the device, a memory type of a memory of the device, a processor type and/or speed of a processor of the device, an operating system type of an operating system of the device, a serial number for the device, a model type for the device, a battery health of a battery of the device, information identifying whether the device is connected to a user account of a user, information identifying whether a reset or reformat has been performed on the device, an international mobile equipment identity (IMIE) number for the device, information identifying components of the device, information identifying sensors and/or types of sensors of the device, information identifying applications on the device, data of the device, or a combination thereof. In certain embodiments, the wired reader 200 can include additional components, such as, but not limited to, a processor, a memory, a storage device, a communication module, a flashing tool, and/or any other components, which can perform operative functionality as described herein.

In certain embodiments, the wired reader 200 itself can determine a status of the device connected thereto, however, in certain embodiments, the computing device 230 can determine the status of the device connected to the wireless reader 200 based on the information obtained from the device (e.g., device 322). In certain embodiments, the status of the device can be whether the device is still connected with and/or otherwise associated with a user account, whether the device has been reset and/or reformatted and/or needs to be reset and/or formatted, whether the device has a threshold battery health level, whether the device components are operating as intended, whether functionality of the device and/or software installed on the device are operating as intended, whether there are any detected errors, damage, and/or information of interest, what type of settings are enabled and/or set for the device, whether the device is communicatively linked and/or connected to any other devices, whether the device is exchanging data with any other device, any other status information, or a combination thereof.

In certain embodiments, the wired device 200 and/or computing device 230 can determine whether an operation and/or activity needs to be performed with respect to the connected device. The operation and/or activity, for example, can include, but is not limited to, performing a factory reset, performing a reformat operation, erasing settings, configurations, and/or applications, disconnecting and/or disassociating the device from a user account, performing any other operations and/or activities, or a combination thereof. In certain embodiments, the computing device 230 can generate and/or provide a signal to the display device 240 to cause the display device to display the information associated with the device, the status of the device, and/or an indication indicating whether an operation and/or activity needs to be performed with respect to the device. Once the activity and/or operation are performed by a user and/or components of the system (e.g., if the operation to be performed is a factory reset, the flashing tool of the wired device can perform the reset), the displayed information can be updated to indicate that the action and/or activity has been performed and/or that the device is ready, such as for a next stage in a reverse logistics process.

In addition to the wired device 200, the system 100 can also include the wireless reader device 210. In certain embodiments, wireless reader device 210 can include any of the components and/or functionality of wireless reader device 125, in addition to additional components. In certain embodiments, the wireless reader device 210 can include a housing 211, any number of wireless components 212, 214, 216, 218, a processor, a memory, a storage device, a communication module, a flashing tool, any number of ports (e.g., to connect with the computing device 230 wired reader 210, the display device 240, and/or any other device). The flashing tool can be configured to be hardware, software, or a combination of hardware and software that is configured to update, modify, or replace software and/or settings of a device, such as, but not limited to, firmware, an operation system, and/or other software of a device. In certain embodiments, the flashing tool can be configured to perform a factory reset, a reformat, and/or any other operation with respect to the device positioned on the wireless reader device 210. As with the wired reader 200, the wireless reader device 210 can read information associated with a device (e.g., device 302) positioned onto one of the wireless components 212, 214, 216, 218. For example, the device can be positioned onto wireless component 212, which can magnetically (or otherwise) couple with the device 302 when the bottom portion of the device 302 is positioned on the wireless component 212. Once positioned on the wireless component 212, the wireless component 212 can charge the device 302, read information from the device 302, and/or perform other operations and/or actions. For example, the wireless reader device 210 either automatically and/or in response to a command issued from the computing device 230, can generate and provide a signal including the read information associated with the device 302 to the computing device 230. Any number of devices can be read by the wireless reader device 210 either simultaneously, in sequence, and/or in any other order.

In certain embodiments, the wireless reader device 210 itself can determine a status of the device positioned thereon, however, in certain embodiments, the computing device 230 can determine the status of the device positioned on the wireless reader device 210 based on the information obtained from the device (e.g., device 302). In certain embodiments, the wireless reader device 210 and/or computing device 230 can determine whether an operation and/or activity needs to be performed with respect to the connected device 302. The operation and/or activity, for example, can include, but is not limited to, performing a factory reset, performing a reformat operation, erasing settings, configurations, and/or applications, disconnecting and/or disassociating the device from a user account, performing any other operations and/or activities, or a combination thereof. In certain embodiments, the computing device 230 can generate and/or provide a signal to the display device 240 to cause the display device to display the information associated with the device, the status of the device, and/or an indication indicating whether an operation and/or activity needs to be performed with respect to the device. Once the activity and/or operation are performed by a user and/or components of the system (e.g., if the operation to be performed is a factory reset, for example, the flashing tool of the wireless reader device 210 can perform the reset), the displayed information can be updated to indicate that the action and/or activity has been performed and/or that the device is ready, such as for a next stage in a reverse logistics process.

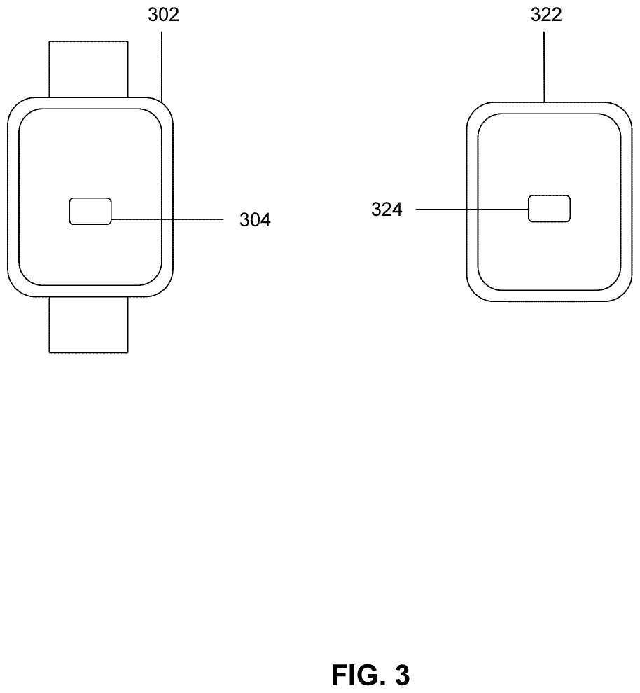

Referring now also to FIG. 3, exemplary devices 302, 322 that can be read by the wired reader 200 and/or wireless reader devices 125, 210 are shown. The devices 302, 322 can be any type of device including, but not limited to, a smart watch, a mobile device, a smartphone, a laptop, a computer, a wearable device, any type of device, or a combination thereof. The devices 302, 322 can include any number of components 304, 324 respectively including, but not limited to, processors, memories, communication modules, sensors, storage devices, circuitry, diagnostic tools and/or ports, any number of ports, any types of components, or a combination thereof.

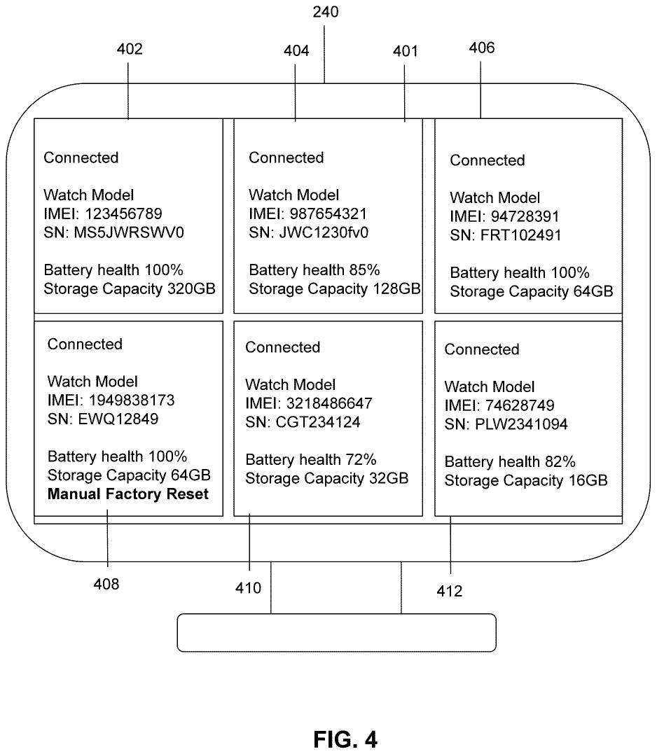

Referring now also to FIG. 4, an exemplary display device 240 is shown featuring an interface 401 for displaying information associated with a device (e.g., information read by the wired and/or wireless readers 200, 210), status information for a device, and/or operations and/or activities to be performed for a device. In certain embodiments, the displayed information for each device can be separated into individual rendered tiles 402, 404, 406, 408, 410, 412 so that a user viewing the display device 240 can readily see the information for a particular device easily. For example, a first device's information can be displayed in a first tile 402 that indicates the device model, IMEI number, serial number, battery health percentage, storage capacity, any other information, or a combination hereof. Similarly rendered tiles 404, 406, 410, and 412 can display corresponding information for corresponding other devices. In certain embodiments, a certain device can have an activity or operation that needs to be performed, such as a manual factory reset, and such information can be displayed in the corresponding tile for the device, such as tile 408. Once the user and/or a device and/or application of the system 100 performs the operation and/or activity, the displayed information in the tile 408 can be updated in real time to reflect that the device is now ready, such as for a next stage in a reverse logistics process. For example, the information displayed in tile 408 can have been presented with an orange background before the action and/or activity has been performed, and once the activity is performed, the background color can be changed from orange to green to shown that the action has been performed and that the device is ready. In certain embodiments, a tile format for presenting the information does not need to be utilized, and any other desired format for displaying information associated with devices can be utilized. The information displayed on the display device can be updated in real time. For example, if a user manually performed a factory reset after removing the device from the wireless reader device 210, and then repositions the device back onto the wireless reader device 210, the system 100 can re-read the device information and update the displayed information on the display device 240 automatically and/or in response to a command from the computing device 230.

Notably, as shown in FIG. 1, the system 100 may perform any of the operative functions disclosed herein by utilizing the processing capabilities of server 160, the storage capacity of the database 155, or any other component of the system 100 to perform the operative functions disclosed herein. The server 160 may include one or more processors 162 that may be configured to process any of the various functions of the system 100. The processors 162 may be software, hardware, or a combination of hardware and software. Additionally, the server 160 may also include a memory 161, which stores instructions that the processors 162 may execute to perform various operations of the system 100. For example, the server 160 may assist in processing loads handled by the various devices in the system 100, such as, but not limited to, communicatively linking devices to wired and/or wireless reader devices, communicatively linking the wired and/or wireless reader devices to computing devices, reading information from devices, providing information read from devices to other devices of the system 100, determining statuses of each device, determining whether operations and/or activities need to be performed with respect to each device, providing signals to cause a display device to display information associated with a device and/or the status of the device, determining whether operations and/or activities have been performed with respect to the device, updating information displayed on the display device after operations and/or activities have been performed with respect to the device, and/or performing any other operations conducted in the system 100 or otherwise. In certain embodiments, multiple servers 160 may be utilized to process the functions of the system 100. In certain embodiments, the server 160 and other devices in the system 100, may utilize the database 155 for storing data about the devices in the system 100 or any other information that is associated with the system 100. In certain embodiments, multiple databases 155 may be utilized to store data in the system 100.

Although FIGS. 1-4 illustrate specific example configurations of the various components of the system 100, the system 100 may include any configuration of the components, which may include using a greater or lesser number of the components. For example, the system 100 is illustratively shown as including a first user device 102, a second user device 111, wireless reader devices 125, a communications network 135, a server 140, a server 145, a server 150, a server 160, a database 155, wired reader device 200, wireless reader device 210, computing device 230, display device 240, device 302, and device 322. However, the system 100 may include multiple first user devices 102, multiple second user devices 111, multiple wireless reader devices 125, multiple communications networks 135, multiple servers 140, multiple servers 145, multiple servers 150, multiple servers 160, multiple databases 155, multiple wired reader devices 200, multiple wireless reader devices 210, multiple computing devices 230, multiple display devices 240, multiple devices 302, multiple devices 322, or any number of any of the other components inside or outside the system 100. Furthermore, in certain embodiments, substantial portions of the functionality and operations of the system 100 may be performed by other networks and systems that may be connected to system 100.

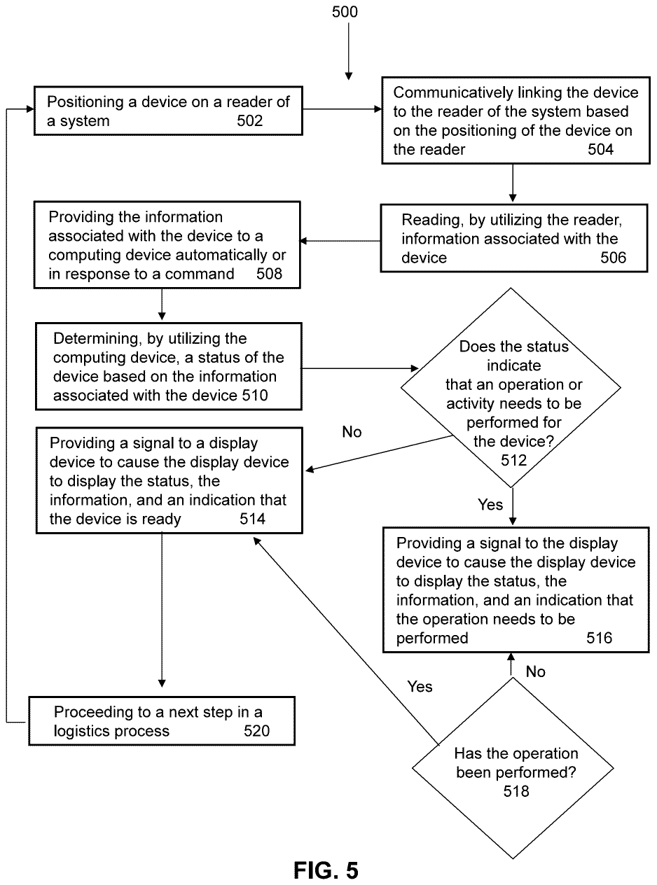

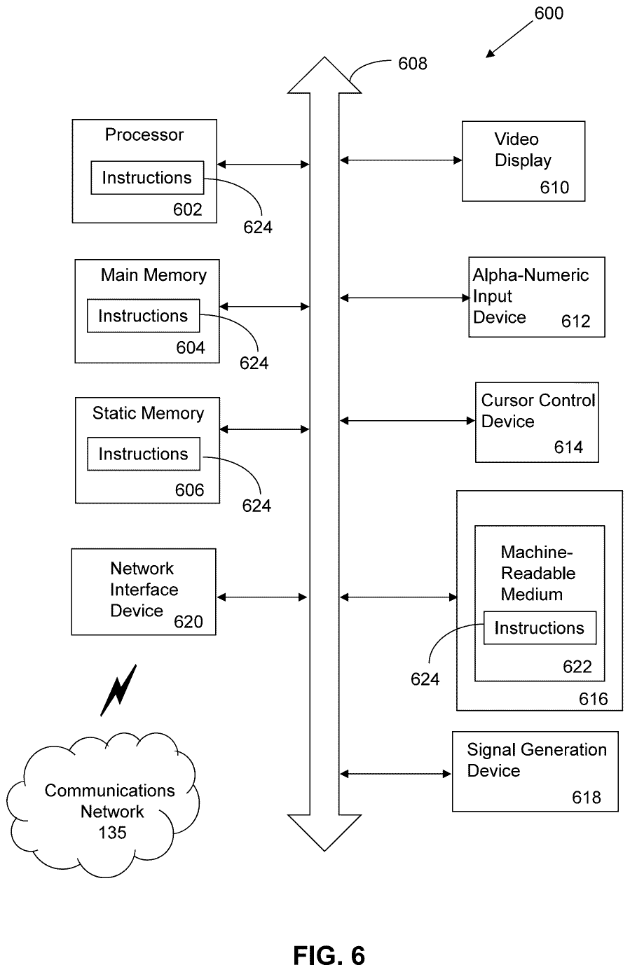

Notably, the system 100 may execute and/or conduct the functionality as described in the method(s) that follow. As shown in FIG. 5, an exemplary method 500 for facilitating access to device information is schematically illustrated. In certain embodiments, the method of FIG. 5 can be implemented in the system of FIG. 1, the system of FIG. 6, and/or any of the other systems, devices, and/or componentry illustrated in the Figures. In certain embodiments, the method of FIG. 500 may be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In certain embodiments, the method of FIG. 5 can be performed at least in part by one or more processing devices (e.g., processor 102, processor 122, processor 141, processor 146, processor 151, and processor 161 of FIG. 1). In certain embodiments, the method of FIG. 500 can be performed by one or more of any of the components shown in the Figures. Although shown in a particular sequence or order, unless otherwise specified, the order of the steps in the method 500 can be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In certain embodiments, the method 500 and/or functionality and features supporting the method 500 can be conducted via an application of the system 100, devices of the system 100 (e.g., first user device 102, wireless reader device 125, wireless reader device 210, wired reader device 200, computing device 230, display device 240, devices 302, 322, etc.), processes of the system 100, any component of the system 100, or a combination thereof. Generally, the method 500 may include steps for positioning a device onto a reader of the system 100, communicatively linking the device to the reader of the system 100 based on the positioning of the device, reading information associated with the device by utilizing the reader, providing the information associated with the device to a computing device automatically or in response to a command from the computing device, determining a status of the device based on the information associated with the device, determining whether the status indicates that an operation or activity needs to be performed with respect to the device, providing a signal to a display device to cause the display device to display the status, the information, and/or an indication that the device is ready, providing a signal to a display device to cause the display device to indicate that an operation needs to be performed, determining whether the operations has been performed, and then proceeding to a next step in a process, such as reverse logistics process.

At step 502, the method 500 can include positioning a device, such as a smart watch (e.g., first user device 102), on a reader of a system 100. In certain embodiments, the positioning can include connecting a port (e.g., diagnostic port) of the device to a connector of a wired reader (e.g., wired reader 200) including pins configured to connect with the port of the device so that the device and wired reader can exchange information and the wired reader and read information associated with the device. In certain embodiments, the positioning can include placing a portion of the device (e.g., underside of the device where a charging coil of the device is located) on top of a wireless charging component of a wireless reader device (e.g., wireless reader device 125, 210). At step 504, the method 500 can include communicatively linking the device to the reader, whether it be the wired reader, the wireless reader, or a combination thereof. With regard to the wired reader, when the device with the port is connected to the connector of the reader device, the wired reader and the device can be communicatively connected. With regard to the wireless reader device, when the portion of the device is positioned onto the wireless charging component of the wireless reader device, the charging component can utilize magnetic induction to transfer power to the device positioned thereon. For example, the wireless charging component can contain a coil that generates a magnetic field when electricity flows through it. When placed near the wireless charging component of the wireless reader, the charging coil of the device can act as a receiver and an electrical current can be induced in the charging coil of the device by the magnetic field generated by the wireless charging component. The electrical current can then be converted into DC power by the circuitry of the device (e.g., smart watch) to charge the power source (e.g., battery) of the device. Additionally, in certain embodiments, when the device and the wireless charging component are connected based on the positioning of the device on the wireless charging component, the wireless reader can also be configured to exchange data with the device positioned thereon. In certain embodiments, the wireless reader device can emit a signal to wirelessly connect with a communication module and/or wireless diagnostic interface of the device to establish a wireless connection to enable the exchange of data between the device and the wireless reader device. In certain embodiments, the wireless reader device can include authentication components (e.g., an authentication chip) to authenticate with the device.

At step 506, the method 500 can include reading, by utilizing the reader, the information associated with the device communicatively linked to the reader. For example, the wired reader can read information associated with the device connected to the connector of the wired reader and the wireless reader device can read the information associated with the device wirelessly connected to the wireless reader device. The information that can be read from the device can include, but is not limited to, a size of a storage of the device, a memory type of a memory of the device, a processor type and/or speed of a processor of the device, an operating system type of an operating system of the device, a serial number for the device, a model type for the device, a battery health of a battery of the device, information identifying whether the device is connected to a user account of a user, information identifying whether a reset or reformat has been performed on the device, an international mobile equipment identity (IMIE) number for the device, information identifying components of the device, information identifying sensors and/or types of sensors of the device, information identifying applications on the device, data of the device, or a combination thereof.

At step 508, the method 500 can include providing the information associated with the device(s) read by the wired reader, wireless reader device, or a combination thereof, to a computing device (e.g., computing device 230). For example, in certain embodiments, the information associated with the device(s) can be provided automatically by the readers to the computing device. In certain embodiments, the information associated with the device(s) can be provided by the readers to the computing device in response to one or more commands issued by the computing device. A command can be a command(s) that requests the information directly from the readers, a command(s) that automatically executes upon positioning and/or connection of a device(s) with the wireless and/or wired reader devices, any other type of command, or a combination thereof. Once the information associated with the device read by the wired reader, wireless reader device, or a combination thereof, is provided to the computing device, the method 500 can proceed to step 510. At step 510, the method 500 can include determining a status of the device based on the received information associated with the device. For example, a status of the device can be whether the device is still connected with and/or otherwise associated with a user account, whether the device has been reset and/or reformatted and/or needs to be reset and/or formatted, whether the device has a threshold battery health level, whether the device components are operating as intended, whether functionality of the device and/or software installed on the device are operating as intended, whether there are any detected errors, damage, and/or information of interest, what type of settings are enabled and/or set for the device, whether the device is communicatively linked and/or connected to any other devices, whether the device is exchanging data with any other device, any other status information, or a combination thereof. In certain embodiments, the status of the device(s) can be determined by the computing device, the wired reader, the wireless reader, any other components illustrated in FIGS. 1-6, or a combination thereof.

At step 512, the method 500 can include determining whether the status indicates that an operation or activity needs to be performed with respect to the device(s). For example, the operation can include performing a reset and/or reformat of the device(s), disabling certain settings and/or features of the device(s), activating certain settings and/or features of the device(s), disconnecting or connecting the device with another device, updating software for the device(s), removing a software update performed on the device(s), charging the device(s), perform any action with respect to the device(s), or a combination thereof. In certain embodiments, the determining of the status can be performed by utilizing the computing device, the wireless reader device, the wired reader, any other components illustrated in FIGS. 1-6, or a combination thereof. If no operation or activity needs to be performed with respect to the device(s), the method 500 can proceed from step 512 to step 514. At step 514, the method 500 can include generating and providing a signal to a display device (e.g., display device 240) to cause the display device to display the status, the information associated with the device, and/or an indication that the device is ready. In certain embodiments, the status, the information, and/or the indication for each device can be displayed in a dedicated region of an interface of the display device. For example, the foregoing information for a first device can be displayed in a top left tile rendered on the display device, information for a second device can be displayed in a middle tile rendered on the display device, information for a third device can be displayed in a right tile rendered on the display device, and so forth. The indication that the device is ready can serve to let a customer representative know that a particular device may be ready for a next step in in the reverse logistics process. If a particular device is ready, the method 500 can proceed to step 520, which can involve proceeding to the next step in the reverse logistics process. For example, the next step can be repackaging the device for shipment to a distributor or manufacturer, or performing some other action with respect to the device.

If however, at step 512, the status indicates that an operation and/or activity needs to be performed for the device, the method 500 can proceed to step 516. At step 516, the method 500 can include generating and providing a signal to the display device to display the status, the information associated with the device, and an indication that an operation and/or activity needs to be performed with respect to the device. For example, the indication can indicate that a manual factory reset needs to be performed on the device and that the device needs to be reconnected to the reader, wireless reader, or a combination thereof, after performing the factory reset. Similarly, indications to perform any other actions can be displayed as well. At step 518, the method 500 can include determining whether the operation and/or activity has been performed. In certain embodiments, the determination can be performed by the computing device, the wireless reader, the wired reader, or a combination thereof. For example, the determination can be performed after the operation and/or activity has been performed (e.g., by a user, by a component of the system 100, or a combination thereof), and the device has been reconnected and/or communicatively linked to the wired reader and/or wireless reader device.

If the operation and/or activity has not been performed (e.g., by reading the device by utilizing the wired and/or wireless reader devise), the method 500 can proceed back to step 516 and redisplay the indication on the display device. If, however, the operation and/or activity has been performed, the method 500 can proceed to step 514, which can include generating and providing a signal to the display device to cause the display device to display the status, the information, and an indication that the device is ready. The method 500 can then proceed to step 520, which can include proceeding to a next step in a logistics process, such as a reverse logistics process for the device. Notably, the method 500 can be modified, supplemented, and/or otherwise altered to incorporate any of the functionality of the present disclosure. Additionally, the method 500 can be repeated as desired. For example, after step 520, the method 500 can proceed back to step 502 for any number of devices.

The systems and methods disclosed herein may include still further functionality and features. For example, the operative functions of the system 100 and method may be configured to execute on a special-purpose processor specifically configured to carry out the operations provided by the system 100 and method. Notably, the operative features and functionality provided by the system 100 and method may increase the efficiency of computing devices that are being utilized to facilitate the functionality provided by the system 100 and the various methods discloses herein. For example, by training the system 100 over time based on data and/or other information read, provided, and/or generated in the system 100, a reduced amount of computer operations may need to be performed by the devices in the system 100 using the processors and memories of the system 100 than compared to traditional methodologies. For example, the system 100 can learn over time that certain models of devices being read by the system 100 tend to have to have certain operations performed on them versus other types of models of devices. In such a context, less processing power needs to be utilized because the processors and memories do not need to be dedicated for processing and can automatically prompt a user of a device to inquire as to whether the operation was performed without having to analyze all the device information. As a result, there are substantial savings in the usage of computer resources by utilizing the software, techniques, and algorithms provided in the present disclosure. In certain embodiments, various operative functionality of the system 100 may be configured to execute on one or more graphics processors and/or application specific integrated processors.

Notably, in certain embodiments, various functions and features of the system 100 and methods may operate without any human intervention and may be conducted entirely by computing devices, robotic devices, other devices, or a combination thereof. In certain embodiments, for example, numerous computing devices may interact with devices of the system 100 to provide the functionality supported by the system 100. Additionally, in certain embodiments, the computing devices of the system 100 may operate continuously and without human intervention to reduce the possibility of errors being introduced into the system 100. In certain embodiments, the system 100 and methods may also provide effective computing resource management by utilizing the features and functions described in the present disclosure. For example, in certain embodiments, devices in the system 100 may transmit signals indicating that only a specific quantity of computer processor resources (e.g. processor clock cycles, processor speed, etc.) may be devoted to reading devices, generating signals to cause display of device information and/or status information for devices being read by the system 100, determining whether operations have been performed on devices being read by the system 100, determining statuses of devices being read by the system 100, and/or performing any other operation conducted by the system 100, or any combination thereof. For example, the signal may indicate a number of processor cycles of a processor may be utilized to specify a selected amount of processing power that may be dedicated to generating or any of the operations performed by the system 100. In certain embodiments, a signal indicating the specific amount of computer processor resources or computer memory resources to be utilized for performing an operation of the system 100 may be transmitted from the first and/or second user devices 102, 111, the wireless reader devices 125, 210, the computing device 230, and/or the wired devices 200 to the various components of the system 100.

The systems, methods, processes, devices, components, functionality, and features described in the present disclosure can be modified, adapted, and/or otherwise configured to be utilized with and support existing technologies and systems, future technologies and systems, or a combination thereof. In certain embodiments, the systems, methods, processes, devices, components, functionality, and features described in the present disclosure can be incorporated into and/or adapted to operate with state-of-the art or equivalent technologies that are in the process of being developed, will be developed in the future, or a combination thereof.

In certain embodiments, any device in the system 100 may transmit a signal to a memory device to cause the memory device to only dedicate a selected amount of memory resources to the various operations of the system 100. In certain embodiments, the system 100 and methods may also include transmitting signals to processors and memories to only perform the operative functions of the system 100 and methods at time periods when usage of processing resources and/or memory resources in the system 100 is at a selected value. In certain embodiments, the system 100 and methods may include transmitting signals to the memory devices utilized in the system 100, which indicate which specific sections of the memory should be utilized to store any of the data utilized or generated by the system 100. Notably, the signals transmitted to the processors and memories may be utilized to optimize the usage of computing resources while executing the operations conducted by the system 100. As a result, such functionality provides substantial operational efficiencies and improvements over existing technologies.

Referring now also to FIG. 6, at least a portion of the methodologies and techniques described with respect to the exemplary embodiments of the system 100 can incorporate a machine, such as, but not limited to, computer system 600, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100. As another example, the computer system 600 may assist with accessing information from devices, displaying the information accessed from devices on a user interface rendered on a display, determining whether an operation needs to be performed with respect to a device, determining whether the operation has been performed, updating information displayed on the user interface rendered on the display, transmitting commands to or from wireless reader devices, requesting operations to be performed with respect to a device, performing any other operation of the present disclosure, or a combination thereof.

In certain embodiments, the machine may operate as a standalone device. In some embodiments, the machine may be connected (e.g., using communications network 135, another network, or a combination thereof) to and assist with operations performed by other machines and systems, such as, but not limited to, the first user device 102, the second user device 111, the wireless reader devices 125, 210, the wired reader device 200, the computing device 230, the display device 240, the devices 302, 322 (e.g., smart watches, mobile devices, and/or other types of devices), the server 140, the server 145, the server 150, the database 155, the server 160, any other system, program, and/or device, or any combination thereof. The machine may be connected with any component in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU, or both), a main memory 604 and a static memory 606, which communicate with each other via a bus 608. The computer system 600 may further include a video display unit 610, which may be, but is not limited to, a liquid crystal display (LCD), a flat panel, a solid state display, or a cathode ray tube (CRT). The computer system 600 may include an input device 612, such as, but not limited to, a keyboard, a cursor control device 614, such as, but not limited to, a mouse, a disk drive unit 616, a signal generation device 618, such as, but not limited to, a speaker or remote control, and a network interface device 620.

In certain embodiments, the disk drive unit 616 may include a machine-readable medium 622 on which is stored one or more sets of instructions 624, such as, but not limited to, software embodying any one or more of the methodologies or functions described herein, including those methods illustrated above. The instructions 624 may also reside, completely or at least partially, within the main memory 604, the static memory 606, or within the processor 602, or a combination thereof, during execution thereof by the computer system 600. In certain embodiments, the main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 622 containing instructions 624 so that a device connected to the communications network 135, another network, or a combination thereof, can send or receive voice, video or data, and communicate over the communications network 135, another network, or a combination thereof, using the instructions. The instructions 624 may further be transmitted or received over the communications network 135, another network, or a combination thereof, via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. In certain embodiments, the “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure is not limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

1. A system, comprising:
a wireless reader device configured to wirelessly read information associated with a first device when the first device is positioned on the wireless reader device; and
a computing device communicatively linked to the wireless reader device and configured to:
transmit a command to the wireless reader device to provide the information associated with the first device positioned on the wireless reader device.

2. The system of claim 1, wherein the computing device is further configured to:
receive, in response to the command and from the wireless reader device, the information associated with the first device wirelessly read from the first device; and
generate a first signal comprising the information associated with the first device to cause display of the information associated with the first device on a first region of a user interface;
wherein the wireless reader device comprises:
a plurality of wireless readers positioned on the wireless reader device, wherein the first device is configured to be positioned onto a first wireless reader of the plurality of wireless readers such that the first device magnetically connects to the first wireless reader.

3. The system of claim 2, wherein the first wireless reader is configured to charge a power source of the first device when the first device is magnetically connected to the first wireless reader by inducing a current in a charging coil of the first device.

4. The system of claim 1, wherein the computing device is further configured to determine a status of the first device based on the information associated with the first device wirelessly read from the first device.

5. The system of claim 4, wherein the computing device is further configured to include the status in the first signal causing display of the information associated with the first device on the first region of the user interface.

6. The system of claim 5, wherein the computing device is further configured to provide an indication of an operation to perform with respect to the first device based on the status of the first device.

7. The system of claim 6, wherein the operation comprises performance of a reset of the first device, performance of a reformat of the first device, or a combination thereof.

8. The system of claim 6, wherein the wireless reader device is further configured to:
wirelessly read additional information associated with the first device after the operation has been performed; and
provide the additional information associated with the first device to the computing device.

9. The system of claim 8, wherein the computing device is further configured to:
determine, based on the additional information, that the operation has been performed; and
generate, based on the additional information, a second signal to cause display of an indication that the operation has been performed at the first region of the user interface.

10. The system of claim 1, further comprising a wired reader configured to:
read information associated with a second device when the second device is connected to a first connector of a plurality of connectors the wired reader; and
provide the information associated with the second device to the computing device.

11. The system of claim 10, wherein the computing device is further configured to:
generate a second signal comprising the information associated with the second device to cause display of the information associated with the second device on a second region of the user interface.

12. The system of claim 1, further comprising a display device comprising the user interface and configured to display the information associated with the first device on the first region of the user interface.

13. The system of claim 1, wherein the wireless reader device is configured to perform a reset, a reformat, or a combination thereof, for the first device when the first device is positioned on the wireless reader device.

14. A device, comprising:
a housing; and
at least one wireless reader incorporating into the housing, wherein a first wireless reader of the at least one wireless reader is configured to:
communicatively link to a first device when the first device is positioned on the at least one wireless reader, wherein the first device magnetically connects to the at least one wireless reader.

15. The device of claim 14, wherein the at least one wireless reader is configured to:
wirelessly read information associated with the first device when the first device is positioned on the at least one wireless reader and communicatively linked to the first device; and
provide, in response to a command from a computing device, the information associated with the first device to the computing device to generate a signal to cause a display to output the information associated with the first device on a first region of a user interface;
wherein the at least one wireless reader communicatively links with the first device when the first device is positioned on the at least one wireless reader by activating a wireless module of the first device via an activation signal.

16. The device of claim 14, wherein the at least one wireless reader comprises a flashing tool configured to:
reset the first device, reformat the first device, update software on the first device, or a combination thereof, when the first device is communicatively linked to the at least one wireless reader.

17. The device of claim 14, wherein the at least one wireless reader is configured to cause a prompt to display on an interface of the first device indicating that an operation needs to be performed on the first device.

18. A method, comprising:
positioning a first device on a wireless reader of a wireless reader device;
communicatively linking the first device to the wireless reader device based on the positioning of the first device on the wireless reader;
reading, by utilizing the wireless reader, information associated with the first device; and
providing the information associated with the first device to a computing device.

19. The method of claim 18, further comprising:
determining, by utilizing the computing device, a status of the first device based on the information associated with the first device;
generating, by utilizing the computing device, a signal to cause display of the information and the status associated with the first device on a first region of a user interface; and
determining if an operation needs to be performed on the first device based on the information associated with the first device.

20. The method of claim 19, further comprising causing an alert to be displayed on the first device indicating that the operation needs to be performed on the first device.
